(19) United States
(12) Patent Application Publication
(10) Pub. No.: US 2024/0030422 A1
(43) Pub. Date: Jan. 25, 2024

(54) ELECTRODE ACTIVE MATERIAL Si PARTICLES, ELECTRODE COMPOUND MATERIAL, LITHIUM-ION BATTERY AND METHOD FOR PRODUCING ELECTRODE ACTIVE MATERIAL Si PARTICLES

(71) Applicant: TOYOTA JIDOSHA KABUSHIKI KAISHA, Toyota-shi (JP)

(72) Inventors: Naohiro MASHIMO, Susono-shi (JP); Mitsutoshi OTAKI, Susono-shi (JP); Jun YOSHIDA, Mishima-shi (JP); Masanori HARATA, Kariya-shi (JP); Yasuhiro YAMAGUCHI, Kariya-shi (JP); Kota URABE, Kariya-shi (JP); Tatsuya EGUCHI, Kariya-shi (JP)

(73) Assignee: TOYOTA JIDOSHA KABUSHIKI KAISHA, Toyota-shi (JP)

(21) Appl. No.: 18/352,665

(22) Filed: Jul. 14, 2023

(30) Foreign Application Priority Data
Jul. 20, 2022 (JP) 2022-115756

(51) Int. Cl. H01M 4/38; H01M 10/0525; H01M 10/0585; C01B 33/027

(52) U.S. Cl. CPC H01M 4/386; H01M 10/0525; H01M 10/0585; C01B 33/027; H01M 2004/021

(57) ABSTRACT

The main object of the disclosure is to provide electrode active material Si particles that can inhibit fluctuation in constraining pressure of a battery during charge-discharge. The electrode active material Si particles have clathrate-type Si and diamond-type Si in the same particles. The electrode active material Si particles preferably comprise diamond-type Si at an area % of 0.05 to 11.00 with respect to the entire electrode active material Si particles. Preferably, the clathrate-type Si at least partially has a clathrate type II structure. The electrode active material Si particles preferably have a porous structure.

### FIELD

The present disclosure relates to electrode active material Si particles, to an electrode compound material, to a lithium-ion battery and to a method for producing electrode active material Si particles.

### BACKGROUND

In recent years, there has been an ongoing surge in the development of batteries. In the automotive industry, for example, development of batteries for electric vehicles and hybrid vehicles continues to advance. Si is one active material known for use in batteries.

PTL 1 discloses an active material having a silicon clathrate type II crystal phase, having voids inside the primary particles, and comprising 0.05 cc/g to 0.15 cc/g voids with pore diameters of 100 nm or smaller.

### CITATION LIST

### Patent Literature

[PTL 1] Japanese Unexamined Patent Publication No. 2021-158004

### SUMMARY

### Technical Problem

As explained above, Si particles used as an active material are effective for achieving high energy density for batteries, but they also result in significant volume change during charge-discharge. Expansion and contraction of the active material causes fluctuation in the constraining pressure of the battery. The means for reducing fluctuation in the constraining pressure of a battery may be by inhibiting expansion and contraction of the active material that occurs with charge-discharge.

The Si particles with the clathrate structure described in PTL 1 are advantageous for reducing volume change during charge-discharge.

The main object of the disclosure is to provide electrode active material Si particles that can inhibit fluctuation in the constraining pressure of a battery during charge-discharge.

### Solution to Problem

The present inventors have found that the aforementioned object can be achieved by the following means:

### <Aspect 1>

Electrode active material Si particles having clathrate-type Si and diamond-type Si in the same particles.

### <Aspect 2>

The electrode active material Si particles according to aspect 1, which comprise diamond-type Si at an area % of 0.05 to 11.00 with respect to the entire electrode active material Si particles.

### <Aspect 3>

The electrode active material Si particles according to aspect 1 or 2, wherein the clathrate-type Si at least partially has a clathrate type II structure.

### <Aspect 4>

The electrode active material Si particles according to any one of aspects 1 to 3, which have a porous structure.

### <Aspect 5>

An electrode compound material comprising electrode active material Si particles according to any one of aspects 1 to 4.

### <Aspect 6>

A lithium-ion battery having a negative electrode layer comprising an electrode compound material according to aspect 5, an electrolyte layer and a positive electrode layer, in that order.

### <Aspect 7>

The lithium-ion battery according to aspect 6, wherein the separator layer is a solid electrolyte layer.

### <Aspect 8>

A method for producing electrode active material Si particles, which comprises: mixing NaSi alloy powder and a Na trap agent and heating them at a heating temperature of 250 to 500° C. for a heating time of 30 to 200 hours, to obtain Si particles having a clathrate structure.

### <Aspect 9>

The method according to aspect 8, wherein the mean primary particle size of the Na trap agent is 60 to 80 μm as D50.

### <Aspect 10>

The method according to aspect 8 or 9, which includes mechanically milling Si powder and NaH powder and heating them at a heating temperature of 250 to 350° C. for a heating time of 1 to 20 hours, or at a heating temperature of 400 to 800° C. for a heating time of 30 to 100 hours, to obtain the NaSi alloy powder.

### Advantageous Effects of Invention

The present disclosure provides primarily electrode active material Si particles that can inhibit fluctuation in constraining pressure of a battery during charge-discharge.

### BRIEF DESCRIPTION OF DRAWINGS

FIG. 1 is a schematic view showing a lithium-ion battery according to a first embodiment of the disclosure.

FIG. 2 is an ASTAR image of the electrode active material Si particles of Example 4.

FIG. 3 is a graph showing the content ratio of clathrate type I Si, clathrate type II Si and diamond-type Si, for the electrode active material Si particles of Example 4.

### DESCRIPTION OF EMBODIMENTS

Embodiments of the disclosure will now be described in detail. However, the disclosure is not limited to the embodiments described below, and various modifications may be implemented which do not depart from the gist thereof.

### <Electrode Active Material Si Particles>

The electrode active material Si particles of the disclosure are Si particles having clathrate-type Si and diamond-type Si in the same particles.

The phrase “in the same particles” means that simple secondary particles or simple primary particles have clathrate-type Si and diamond-type Si. It is preferred for simple primary particles to have clathrate-type Si and diamond-type Si.

A Si-based active material, such as a Si-based active material used in a lithium-ion battery, is known to exhibit a high degree of expansion and contraction during charge-discharge. Clathrate-type Si particles are an active material that reduces the expansion and contraction of such a Si-based active material during charge-discharge.

The electrode active material Si particles of the disclosure have clathrate-type Si and diamond-type Si in the same particles. Diamond-type Si has higher conductivity compared to clathrate-type Si. Therefore, Si particles having both clathrate-type Si and diamond-type Si in the same particles facilitate diffusion of electrons through the entirety of the particle interiors during charge-discharge, and can reduce reactive imbalance between the clathrate-type Si and the ion carrier, such as lithium, for example, in the particles, thus helping to reduce imbalance in expansion and contraction of the Si particles during charge-discharge.

Since imbalance in the expansion and contraction of the Si particles during charge-discharge is reduced in a battery using electrode active material Si particles of the disclosure as the active material, fluctuation in constraining pressure of the battery during charge-discharge is also reduced.

Clathrate-type Si is the portion of particles in a Si electrode active material that have a clathrate-type crystalline structure.

Preferably, the clathrate-type Si at least partially has a clathrate type II structure. This is because Si with a clathrate type II structure is able to occlude an ion carrier such as lithium in its interior basket structure, so that the degree of expansion and contraction during charge-discharge tends to be lower compared to other Si-based active materials.

The clathrate Si may also include both clathrate type I and clathrate type II.

The area ratio of clathrate type II Si with respect to the entire electrode active material Si particles may be 50.00 to 99.05 area %. The area ratio of clathrate type II Si with respect to the entire clathrate Si may be 50.00 area % or greater, 60.00 area % or greater, 70.00 area % or greater or 80.00 area % or greater, and 99.05 area % or lower, 98.00 area % or lower, 95.00 area % or lower or 90.00 area % or lower.

The area ratio of clathrate type II Si with respect to the entire electrode active material Si particles can be calculated by the area ratio of each composition during analysis.

Diamond-type Si is the portion of the electrode active material Si particles having a diamond-type structure.

The area ratio of diamond-type Si with respect to the entire electrode active material Si particles is preferably 0.05 to 11.00 area %.

If the electrode active material Si particles contain diamond-type Si at 0.05 area % or greater it will be possible to adequately reduce fluctuation in constraining pressure of the battery during charge-discharge. This is due to the improved conductivity of electrode active material Si particles, which can reduce reactive imbalance between the clathrate-type Si and the ion carrier, such as lithium, for example, thus helping to reduce imbalance in expansion and contraction of the Si particles during charge-discharge.

If, on the other hand, the electrode active material Si particles comprise diamond-type Si at more than 11.00 area %, the proportion of clathrate-type Si in the electrode active material Si particles is lowered, resulting in insufficient inhibition of volume change in the electrode active material Si particles.

The area ratio of diamond-type Si with respect to the entire electrode active material Si particles may be 0.05 area % or greater, 0.10 area % or greater, 0.20 area % or greater or 0.40 area % or greater, and 11.00 area % or lower, 10.00 area % or lower, 9.00 area % or lower or 8.00 area % or lower.

From the viewpoint of further inhibiting fluctuation in constraining pressure, the area ratio of diamond-type Si with respect to the entire electrode active material Si particles is most preferably 0.40 to 8.00 area %.

The area ratio of diamond-type Si with respect to the entire electrode active material Si particles can be calculated by the area ratio of each composition during analysis.

The portions other than the clathrate-type Si and diamond-type Si among the entire electrode active material Si particles may be amorphous, for example. The portions other than the clathrate type II Si of the entire clathrate-type Si may be clathrate type I Si.

The electrode active material Si particles more preferably have a porous structure.

The presence or absence of a porous structure can be confirmed from an image taken with a scanning electron microscope (SEM), for example.

The porous structure may be a structure with numerous pores, and more specifically a nanoporous structure, mesoporous structure or macroporous structure. A nanoporous structure is a porous structure with a pore distribution of 0.5 to 2.0 nm, for example. A mesoporous structure is a porous structure with a pore distribution of 2.0 to 50.0 nm, for example. A macroporous structure is a porous structure with a pore distribution of 50.0 to 1000.0 nm, for example. The pore distribution of the electrode active material Si particles can be measured by the N₂ gas adsorption method, as an example.

### <Electrode Compound Material>

The electrode compound material of the disclosure comprises electrode active material Si particles according to the disclosure.

The electrode compound material of the disclosure may optionally further comprise a solid electrolyte, a conductive aid and a binder, in addition to the electrode active material Si particles of the disclosure.

The electrode compound material of the disclosure may be obtained using a publicly known method, except for using the electrode active material Si particles of the disclosure.

### <Solid Electrolyte>

The material of the solid electrolyte is not particularly restricted, and it may be any material that can be used as a solid electrolyte for a lithium-ion battery. For example, the solid electrolyte may be a sulfide solid electrolyte, an oxide solid electrolyte or a polymer electrolyte, although this is not limitative.

Examples of sulfide solid electrolytes include, but are not limited to, sulfide-based amorphous solid electrolytes, sulfide-based crystalline solid electrolytes and argyrodite solid electrolytes. Specific examples of sulfide solid electrolytes include, but are not limited to, Li₂S—P₂S₅ (Li₇P₃S₁₁, Li₃PS₄, Li₈P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂), LiI—Li₂S—P₂O₅, LiI—Li₃PO₄—P₂S₅ and Li₇₋ₓPS₆₋ₓClₓ, as well as combinations thereof.

Examples of oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄ and Li₃₊ₓPO₄₋ₓNₓ(LiPON).

The sulfide solid electrolyte and oxide solid electrolyte may be glass or crystallized glass (glass ceramic).

Polymer electrolytes include, but are not limited to, polyethylene oxide (PEO) and polypropylene oxide (PPO), and their copolymers.

### <Conductive Aid>

The conductive aid is not particularly restricted. For example, the conductive aid may be, but is not limited to, a carbon material such as VGCF (Vapor Grown Carbon Fibers) or carbon nanofibers, or a metal material.

### <Binder>

The binder is also not particularly restricted. Examples for the binder include, but are not limited to, materials such as polyvinylidene fluoride (PVdF), butadiene rubber (BR), polytetrafluoroethylene (PTFE) and styrene-butadiene rubber (SBR), or combinations thereof.

### <Lithium-Ion Battery>

The lithium-ion battery of the disclosure may have a negative electrode layer comprising the electrode compound material of the disclosure, an electrolyte layer and a positive electrode layer, in that order. The electrolyte layer may be a solid electrolyte layer.

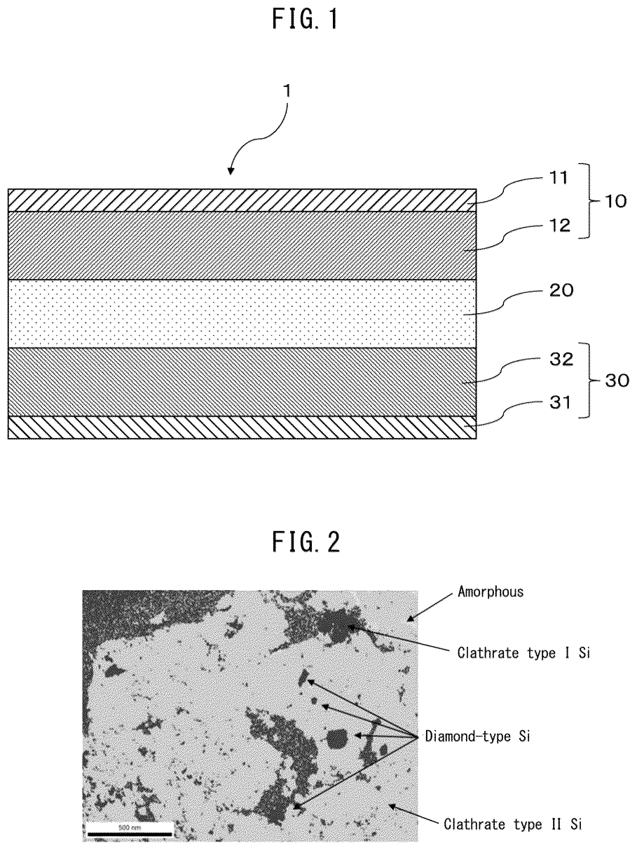

FIG. 1 is a schematic view showing a lithium-ion battery 1 according to one embodiment of the disclosure.

As shown in FIG. 1, the lithium-ion battery 1 according to the first embodiment of the disclosure has a negative electrode layer 10 comprising an electrode compound material of the disclosure, a solid electrolyte layer 20 as an electrolyte layer, and a positive electrode layer 30, in that order. The negative electrode layer 10 has a negative electrode collector layer 11 and a negative electrode active material layer 12. The negative electrode active material layer 12 is in contact with the solid electrolyte layer 20. Likewise, the positive electrode layer 30 has a positive electrode collector layer 31 and a positive electrode active material layer 32. The positive electrode active material layer 32 is in contact with the solid electrolyte layer 20.

### (Negative Electrode Collector Layer)

The material used in the negative electrode collector layer is not particularly restricted, and any one which can be used as a current collector in a battery may be employed as appropriate.

For example, the material used in the negative electrode collector layer may be, but is not limited to, stainless steel (SUS), aluminum, copper, nickel, iron, titanium or carbon. The material of the negative electrode collector layer is preferably copper.

The form of the negative electrode collector layer is not particularly restricted and may be, for example, a foil, sheet, mesh or the like. A foil is preferred among these.

### (Negative Electrode Active Material Layer)

The negative electrode active material layer of the disclosure is a layer comprising an electrode compound material of the disclosure.

The thickness of the negative electrode active material layer is 0.1 μm to 1000 μm, for example.

### <Electrolyte Layer>

The electrolyte layer of the disclosure may be a solid electrolyte layer.

The solid electrolyte layer includes at least a solid electrolyte. The solid electrolyte layer may include a binder or the like if necessary, in addition to a solid electrolyte. The solid electrolyte and binder may be selected with reference to the above description under the heading “<Electrode compound material>”.

The electrolyte layer may be a sheet of a resin such as polypropylene, impregnated with an electrolyte solution having lithium-ion conductivity.

The electrolyte solution preferably comprises a supporting electrolyte and a solvent. The supporting electrolyte (lithium salt) in the electrolyte solution which has lithium-ion conductivity may be an inorganic lithium salt such as LiPF₆, LiBF₄, LiClO₄ or LiAsF₆, or an organic lithium salt such as LiCF₃SO₃, LiN(CF₃SO₂)₂, LiN(C₂F₅SO₂)₂, LiN(FSO₂)₂ or LiC (CF₃SO₂)₃, for example. Examples of solvents to be used in the electrolyte solution include cyclic esters (cyclic carbonates) such as ethylene carbonate (EC), propylene carbonate (PC) and butylene carbonate (BC), and straight-chain esters (straight-chain carbonates) such as dimethyl carbonate (DMC), diethyl carbonate (DEC) and ethylmethyl carbonate (EMC). The electrolyte solution preferably comprises two or more solvents.

The thickness of the electrolyte layer is 0.1 μm to 1000 μm, for example.

### (Positive Electrode Collector Layer)

The materials and form for the positive electrode collector layer are not particularly restricted, and the same materials and form may be used as described above under the heading <Negative electrode collector layer>. The material of the positive electrode collector layer is preferably aluminum. The layer form is preferably a foil.

### (Positive Electrode Active Material Layer)

The positive electrode active material layer is a layer comprising a positive electrode active material, and optionally a solid electrolyte, a conductive aid and a binder.

The material of the positive electrode active material is not particularly restricted. Examples for the positive electrode active material include, but are not limited to, heterogenous element-substituted Li—Mn spinel having a composition represented by lithium cobaltate (LiCoO₂), lithium nickelate (LiNiO₂), lithium manganate (LiMn₂O₄), LiCo_{1/3}Ni_{1/3}Mn_{1/3}O₂ and Li₁₊ₓMn_{2-x-y}M_{y}O₄ (where M is one or more metal elements selected from among Al, Mg, Co, Fe, Ni and Zn).

The positive electrode active material may be in a particulate form, for example. The mean particle diameter (D50) of the positive electrode active material is not particularly restricted but may be 10 nm or larger or 100 nm or larger, for example. The mean particle diameter (D50) of the positive electrode active material may be 50 μm or smaller or 20 μm or smaller, for example. The mean particle diameter (D50) can be calculated using a laser diffraction particle size distribution meter and scanning electron microscope (SEM), for example.

The solid electrolyte, conductive aid and binder may be selected with reference to the above description under the heading “<Electrode compound material>”.

The thickness of the positive electrode active material layer is 0.1 μm to 1000 μm, for example.

### <Method for Producing Electrode Active Material Si Particles>

The method for producing electrode active material Si particles of the disclosure comprises mixing NaSi alloy powder and a Na trap agent and heating them at a heating temperature of 250 to 500° C. for a heating time of 30 to 200 hours, to obtain Si particles having a clathrate structure.

By mixing the NaSi alloy powder and Na trap agent and heating them at a predetermined temperature and for a predetermined time, Na dissociates from the NaSi alloy, generating a clathrate structure, and specifically Si particles with a clathrate type II structure.

The Na trap agent is not limited to one that reacts with NaSi alloy and accepts Na from NaSi alloy, and it may be one that reacts with Na that has dissociated from NaSi alloy, and specifically vaporized Na.

Specific examples for the Na trap agent include particles of CaCl₂, CaBr₂, CaI₂, Fe₃O₄, FeO, MgCl₂, ZnO, ZnCl₂, MnCl₂ and AlF₃. AlF₃ particles are most preferred for the Na trap agent.

The mean particle diameter (D50) of the Na trap agent is preferably 20 to 300 μm. The mean particle diameter (D50) can be calculated using a laser diffraction particle size distribution meter and scanning electron microscope (SEM), for example.

If the mean particle diameter (D50) of the Na trap agent is in this range it will be easier to form diamond-type Si in the Si particles. The mean particle diameter (D50) can be calculated using a laser diffraction particle size distribution meter and scanning electron microscope (SEM), for example.

The mean particle diameter (D50) of the Na trap agent may be 20 μm or greater, 30 μm or greater, 50 μm or greater or 60 μm or greater, and 300 μm or smaller, 200 μm or smaller, 100 μm or smaller or 80 μm or smaller.

Diamond-type Si will form more readily if the heating temperature is 250° C. or higher, and clathrate-type Si will form more readily if the heating temperature is lower than 500° C., and therefore the heating temperature is preferably 250 to 500° C.

The heating temperature may be 250° C. or higher, 300° C. or higher or 350° C. or higher, and 500° C. or lower, 450° C. or lower, 400° C. or lower or 350° C. or lower.

Clathrate-type Si will form more readily if the heating time is 30 hours or longer, and the production efficiency will be higher if the heating time is less than 100 hours, and therefore the heating time is preferably 30 to 200 hours. A longer heating time will tend to result in greater formation of diamond-type Si.

The heating time may be 30 hours or longer, 40 hours or longer, 50 hours or longer or 100 hours or longer, and 200 hours or less, 180 hours or less, 160 hours or less or 100 hours or less.

In the production method of the disclosure, the NaSi alloy powder can be obtained by mechanically milling Si powder and NaH powder and heating them at a heating temperature of 250 to 350° C. for a heating time of 1 to 20 hours, or at a heating temperature of 400 to 800° C. for a heating time of 30 to 100 hours.

Treatment at a relatively low temperature and short time for production of NaSi alloy, specifically at a heating temperature of 250 to 350° C. and for a heating time of 1 to 20 hours, can leave a residue of diamond-type Si in the Si powder material. In this case, the heating temperature may be 250° C. or higher, 260° C. or higher or 270° C. or higher, and 350° C. or lower, 340° C. or lower or 330° C. or lower. The heating time may be 1 hour or longer, 3 hours or longer or 5 hours or longer, and 20 hours or less, 15 hours or less or 10 hours or less.

On the other hand, treatment at a relatively high temperature and for a relatively long time to produce the NaSi alloy, specifically at a heating temperature of 400 to 800° C. and for a heating time of 30 to 100 hours, constitute conditions for more easily forming diamond-type Si crystals. In this case, the heating temperature may be 400° C. or higher, 450° C. or higher or 500° C. or higher, and 800° C. or lower, 700° C. or lower or 600° C. or lower.

### EXAMPLES

### Examples 1 to 6 and Comparative Examples 1 and 2

### Example 1

### (Production of NaSi Alloy Powder)

Na metal and Si powder were weighed out to a molar ratio of 1.1:1 and mixed, and the mixture was kept at 400° C. for 40 hours under an argon atmosphere to melt the components. The mixture was cooled to room temperature to obtain a NaSi alloy ingot. The NaSi alloy ingot was pulverized and sorted in a glove box to obtain NaSi alloy having a particle size of 500 μm or smaller. The compositional ratio of Na with respect to Si in the NaSi alloy was somewhat high.

### (Production of Si Particles)

NaSi alloy and AlF₃ were weighed out to a molar ratio of 1:0.75 and mixed using a cutter mill to obtain a reaction starting material. The obtained powdered reaction starting material was placed in a stainless steel reactor and heated for 40 hours in a heating furnace at 270° C. under a nitrogen atmosphere.

The heating furnace was cooled to room temperature and the product was collected from the reactor. The product was loaded into a 3 mass % hydrochloric acid water-soluble solution and stirred for 10 minutes under a N₂ flow for washing. The washed product was filtered and separated, and dried under reduced pressure at 80° C. to obtain electrode active material Si particles for Example 1.

The mean particle diameter (D50) of the AlF₃ particles was 77.9 μm.

### Examples 2 to 6 and Comparative Example 1

Electrode active material Si particles for each Example were obtained in the same manner as Example 1, except that production was carried out with the heating temperatures, heating times and AlF₃ mean particle diameters (D50) listed in Table 1.

### Comparative Example 2

Si Particles with a diamond-type Si structure were used as the electrode active material Si particles for Comparative Example 2.

### <Abundance Ratio of Diamond-Type Si>

An ASTAR TEM Crystal Orientation Analyzer (by TSL Solutions (tsljapan.com)) was used to determine the abundance ratio (area %) of diamond-type Si in the electrode active material Si particles for each Example.

### <Charge-Discharge Test>

Lithium-ion batteries were fabricated using the electrode active material Si particles of each Example as a negative electrode active material, and charge testing was carried out under prescribed conditions, measuring the increase in constraining pressure.

Each lithium-ion battery had a structure with a negative electrode collector layer, a negative electrode active material layer, a solid electrolyte layer, a positive electrode active material layer and a positive electrode collector layer, stacked in that order.

The negative electrode collector layer was a copper foil. The negative electrode active material layer comprised the electrode active material Si particles of each Example, a Li₂S—P₂S₅— based active material as a sulfide solid electrolyte, polyvinylidene fluoride (PVdF) as a binder and VGCF as a conductive aid.

The solid electrolyte layer comprised a Li₂S—P₂S₅-based active material as a sulfide solid electrolyte and polyvinylidene fluoride (PVdF) as a binder.

The positive electrode active material layer comprised lithium manganate (LiMn₂O₄) as a positive electrode active material, polyvinylidene fluoride (PVdF) as a binder and VGCF as a conductive aid.

The positive electrode collector layer was an aluminum foil.

### <Results>

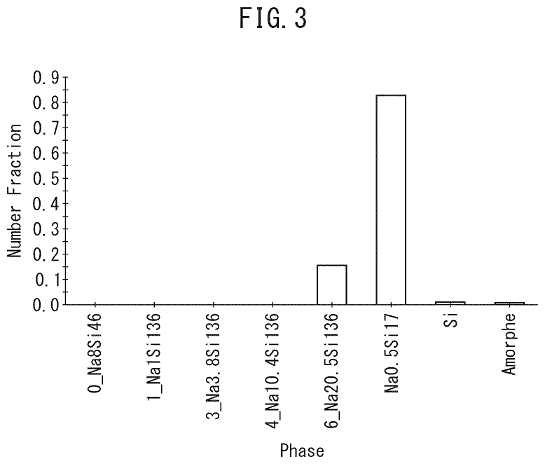

FIGS. 2 and 3 show the ASTAR results for Example 4.

FIG. 2 is an ASTAR image of the electrode active material Si particles of Example 4.

As shown in FIG. 2, the electrode active material Si particles of Example 4 had a clathrate type II Si phase for the major portion, with a clathrate type I Si phase and diamond-type Si phase as well. They also included a trace amount of an amorphous phase.

FIG. 3 is a graph showing the content ratio of clathrate type I Si, clathrate type II Si and diamond-type Si, for the electrode active material Si particles of Example 4.

In FIG. 3, “Na20.5Si136” indicates clathrate type II Si, “Na0.5Si17” indicates clathrate type I Si and “Si” indicates diamond-type Si. FIG. 3 shows that the mass ratios of clathrate type I Si, clathrate type II Si and diamond-type Si with respect to the entire electrode active material Si particles of Example 4 were approximately 14.75, approximately 84.25 and approximately 0.75, respectively.

Table 1 shows the production conditions for the electrode active material Si particles of each Example, electrode active material Si particles, as well as the diamond-type Si mass % and the increase in constraining pressure during charge-discharge when used to construct a lithium-ion battery (relative to 100.0 for Comparative Example 1).

TABLE 1

| | Production conditions | | | | | | | |
|---|---|---|---|---|---|---|---|---|
| | NaSi conversion step | | Na removal step | | | | Results | |
| | Heating | | Heating | | | | | Constraining |
| | temperature | Heating time | temperature | Heating time | AlF₃ mean particle | | Diamond-type Si | pressure increase |
| Example | (° C.) | (hr) | (° C.) | (hr) | diameter (D50) (μm) | | amount (mass %) | (relative value) |
| Comp. Example 1 | 700 | 20 | 385 | 20 | — | | 0.00 | 100.0 |
| Comp. Example 2 | — | — | — | — | — | | 100.00 | 165.2 |
| Example 1 | 400 | 40 | 270 | 40 | 77.9 | μm | 0.05 | 52.2 |
| Example 2 | 400 | 40 | 310 | 60 | 73.88 | μm | 0.40 | 28.3 |
| Example 3 | 300 | 6 | 290 | 160 | 77.9 | μm | 0.65 | 26.1 |
| Example 4 | 400 | 40 | 310 | 60 | 77.9 | μm | 0.75 | 15.2 |
| Example 5 | 400 | 40 | 310 | 60 | 65.23 | μm | 7.8 | 26.1 |
| Example 6 | 400 | 40 | 310 | 60 | 61.51 | μm | 10.7 | 30.4 |

The electrode active material Si particles of Examples 1 to 3, 5 and 6 had diamond-type Si and clathrate type II Si within the same particles, similar to the ASTAR image for the electrode active material Si of Example 4 shown in FIG. 2.

The increases in constraining pressure during charge of the lithium-ion batteries using the electrode active material Si particles of Examples 1 to 6 were lower than the increase in constraining pressure during charge of the lithium-ion battery using the electrode active material Si particles of Comparative Example 1 which did not contain diamond-type Si, their increases being 52.2, 28.3, 26.1, 15.2, 26.1 and 30.4, respectively.

The increase in constraining pressure during charge of the lithium-ion battery using the electrode active material Si particles of Comparative Example 2 which had diamond-type Si alone was 165.2, which was much larger than the increase in constraining pressure during charge of the lithium-ion battery using the electrode active material Si particles of Comparative Example 1.

### REFERENCE SIGNS LIST

1 lithium-ion battery
10 Negative electrode layer
11 Negative electrode collector layer
12 Negative electrode active material layer
20 Solid electrolyte layer
30 Positive electrode layer
31 Positive electrode collector layer
32 Positive electrode active material layer

1. Electrode active material Si particles having clathrate-type Si and diamond-type Si in the same particles.

2. The electrode active material Si particles according to claim 1, which comprise diamond-type Si at an area % of 0.05 to 11.00 with respect to the entire electrode active material Si particles.

3. The electrode active material Si particles according to claim 1, wherein the clathrate-type Si at least partially has a clathrate type II structure.

4. The electrode active material Si particles according to claim 1, which have a porous structure.

5. An electrode compound material comprising electrode active material Si particles according to claim 1.

6. A lithium-ion battery having a negative electrode layer comprising an electrode compound material according to claim 5, an electrolyte layer and a positive electrode layer, in that order.

7. The lithium-ion battery according to claim 6, wherein the separator layer is a solid electrolyte layer.

8. A method for producing electrode active material Si particles, which comprises:
mixing NaSi alloy powder and a Na trap agent and heating them at a heating temperature of 250 to 500° C. for a heating time of 30 to 200 hours, to obtain Si particles having a clathrate structure.

9. The method according to claim 8, wherein the mean particle diameter (D50) of the Na trap agent is 60 to 80 μm.

10. The method according to claim 8, which includes mechanically milling Si powder and NaH powder and heating them at a heating temperature of 250 to 350° C. for a heating time of 1 to 20 hours, or at a heating temperature of 400 to 800° C. for a heating time of 30 to 100 hours, to obtain the NaSi alloy powder.
